(19) United States
(12) Patent Application Publication
(10) Pub. No.: US 2016/0195967 A1
(43) Pub. Date: Jul. 7, 2016

(54) DISPLAY DEVICE

(71) Applicant: Samsung Display Co. Ltd., Yongin City (KR)

(72) Inventors: Eung Kwan LEE, Cheonan-si (KR); Hyun Wook CHO, Cheonan-si (KR)

(21) Appl. No.: 14/699,941

(22) Filed: Apr. 29, 2015

(30) Foreign Application Priority Data
Jan. 5, 2015 (KR) 10-2015-0000621

(51) Int. Cl. G06F 3/041

(52) U.S. Cl. CPC G06F 3/0412

(57) ABSTRACT

A display device includes a first substrate, first and second sensing patterns, first and second sensing wiring units, and a sensing pad unit including first and second sensing pad units. The first sensing pad unit includes first sensing pads connected to the first sensing wiring unit and the second sensing pad unit includes second sensing pads connected to the second sensing wiring unit. One end of the first sensing wiring unit is connected to the first sensing patterns located on one side of the first sensing patterns, and the other end of the first sensing wiring unit is connected to the first sensing patterns located on the other side of the first sensing patterns. The first sensing wiring unit electrically connects the first sensing patterns located on the one side and the first sensing patterns located on the other side to each other through the first sensing pad unit.

### CROSS-REFERENCE TO RELATED APPLICATION

This application claims the priority and benefit of Korean Patent Application No. 10-2015-0000621 filed Jan. 5, 2015 with the Korean Intellectual Property Office, the disclosure of which is incorporated herein by reference in its entirety.

### BACKGROUND

1. Technical Field

The present disclosure generally relates to a display device, and more particularly to a display device including a touch panel having an improved double routing structure.

2. Description of the Related Art

Display devices having embedded touch panels are widely used today. These devices include a screen on which an image is displayed. A user can control and use a device by using a finger or an object to input a command to the device.

The touch panel of the display device may include a plurality of sensing patterns formed on a display region of a display panel and a plurality of sensing wirings for transferring sensing signals to a sensing integrated circuit (IC). The sensing signals may be generated by a plurality of sensing electrodes.

In general, touch panels have a structure in which a plurality of sensing patterns and a plurality of sensing wirings are connected corresponding to each other. The above structure is known as a single routing structure.

Recently, with display devices trending toward larger screens, the number of sensing patterns in a display region on a display panel has increased accordingly. In some instances, when there is a large number of sensing patterns and the sensing patterns are connected to individual sensing wirings in a single routing structure, the degree of sensitivity in sensing a touch input may deteriorate.

To solve the above issue, a double routing structure has been suggested. In the double routing structure, two sensing patterns of a plurality of sensing patterns arranged in a common row or in a common column are connected to a single sensing wiring.

A plurality of sensing wirings are connected to a plurality of sensing pads for transmitting and receiving a sensing signal and a driving signal. In the double routing structure, the number of sensing pads is increased by twice. As a result, the size of a flexible touch circuit board may increase, thereby increasing production costs.

### SUMMARY

The present disclosure addresses at least the above issues, by providing a display device having an improved double routing structure.

According to an exemplary embodiment of the inventive concept, a display device is provided. The display device includes: a first substrate; a plurality of first sensing patterns positioned on a first surface of the first substrate and arranged in a first direction; a plurality of second sensing patterns positioned on the first surface of the first substrate and arranged in a second direction intersecting with the first direction; a first sensing wiring unit including a plurality of first sensing wirings connected to the first sensing patterns; a second sensing wiring unit including a plurality of second sensing wirings connected to the second sensing patterns; and a sensing pad unit including a first sensing pad unit and a second sensing pad unit, wherein the first sensing pad unit includes a plurality of first sensing pads connected to the first sensing wiring unit and the second sensing pad unit includes a plurality of second sensing pads connected to the second sensing wiring unit, wherein one end of the first sensing wiring unit is connected to the first sensing patterns that are located on one side of the first sensing patterns arranged in the first direction, and the other end of the first sensing wiring unit is connected to the first sensing patterns that are located on the other side of the first sensing patterns arranged in the first direction, and wherein the first sensing wiring unit electrically connects the first sensing patterns that are located on the one side and the first sensing patterns that are located on the other side to each other through the first sensing pad unit.

In some embodiments, the first sensing patterns may be electrically connected to each other, and a first connection pattern may electrically connect the first sensing patterns to each other.

In some embodiments, the second sensing patterns may be electrically connected to each other, and a second connection pattern may electrically connect the second sensing patterns to each other.

In some embodiments, the first connection pattern and the second connection pattern may be arranged in different layers.

In some embodiments, an insulating material may be interposed between the first connection pattern and the second connection pattern.

In some embodiments, the second sensing wiring unit may be connected to each of the second sensing patterns.

In some embodiments, one end of the second sensing wiring unit may be connected to the second sensing patterns that are located on one side of the second sensing patterns arranged in the second direction, and the other end of the second sensing wiring unit may be connected to the second sensing patterns that are located on the other side of the second sensing patterns arranged in the second direction.

In some embodiments, the second sensing wiring unit may electrically connect the second sensing patterns that are located on the one side and the second sensing patterns that are located on the other side to each other through the second sensing pad unit.

In some embodiments, the number of the first sensing pads may be half the number of the first sensing patterns.

In some embodiments, the number of the second sensing pads may be the same as the number of the second sensing patterns.

In some embodiments, a second substrate may be disposed on a second surface of the first substrate, and a plurality of pixel regions may be arranged on the second substrate.

According to another exemplary embodiment of the inventive concept, a display device is provided. The display device includes: a substrate; a plurality of first sensing patterns arranged on the substrate in a first direction; a plurality of second sensing patterns arranged on the substrate in a second direction intersecting with the first direction; a plurality of first sensing pads for transmitting sensing signals sensed by the plurality of first sensing patterns; a plurality of second sensing pads for transmitting sensing signals sensed by the plurality of second sensing patterns; a plurality of first sensing wirings electrically connecting the first sensing patterns and the first sensing pads to each other; and a plurality of second sensing wirings electrically connecting the second sensing patterns and the second sensing pads to each other, wherein one side of the first sensing pads are connected to one end of the first sensing wirings that are connected to the first sensing patterns located on one side of the first sensing patterns, and wherein the other side of the first sensing pads are connected to the other end of the first sensing wirings that are connected to the first sensing patterns located on the other side of the first sensing patterns.

In some embodiments, the first sensing pads may be disposed on the substrate, an insulating layer may be interposed between the first sensing pads and the first sensing wirings, and the first sensing pads and the first sensing wirings may be electrically connected to each other through contact holes formed in the insulating layer.

In some embodiments, the number of the first sensing pads may be half the number of the first sensing patterns.

In some embodiments, the second sensing pads may be connected to the second sensing wirings, and the second sensing wirings may be connected to the second sensing patterns.

In some embodiments, the number of the second sensing pads may be the same as the number of the second sensing patterns.

In some embodiments, one side of the second sensing pads may be connected to one end of the second sensing wirings that are connected to the second sensing patterns located on one side of the second sensing patterns, and the other side of the second sensing pads may be connected to the other end of the second sensing wirings that are connected to the second sensing patterns located on the other side of the second sensing patterns.

In some embodiments, the number of the second sensing pads may be half the number of the second sensing patterns.

In some embodiments, the first sensing patterns may be electrically connected to each other, and a first connection pattern may electrically connect the first sensing patterns to each other.

In some embodiments, the second sensing patterns may be electrically connected to each other, and a second connection pattern may electrically connect the second sensing patterns to each other.

### BRIEF DESCRIPTION OF DRAWINGS

The above and other aspects, features and advantages of the inventive concept will be more clearly understood from the following detailed description taken in conjunction with the accompanying drawings.

FIG. 1 is a schematic plan view of a display device according to an exemplary embodiment.

FIG. 2 is a magnified view of region A of FIG. 1.

FIG. 3 is a cross-sectional view taken along line I-I′ of FIG. 2.

FIG. 4 is a cross-sectional view taken along line a-a′ of FIG. 1.

FIG. 5 is a cross-sectional view taken along line b-b′ of FIG. 1.

FIG. 6 is a schematic plan view of a display device according to another exemplary embodiment.

### DETAILED DESCRIPTION

In the following description, for the purposes of explanation, numerous specific details are set forth to provide a thorough understanding of various exemplary embodiments. It is apparent, however, that various exemplary embodiments may be realized without requiring all of the specific details. In other instances, well-known structures and devices are shown in block diagram form in order to avoid unnecessarily obscuring the inventive concept.

In the accompanying figures, the size and relative sizes of layers, films, panels, regions, etc., may be exaggerated for clarity and descriptive purposes. Also, like reference numerals denote like elements.

It will be understood that when an element or layer is referred to as being “on”, “connected to”, or “coupled to” another element or layer, it can be directly on, directly connected to, or directly coupled to the other element or layer, or with one or more intervening elements or layers being present. In contrast, when an element is referred to as being “directly on,” “directly connected to”, or “directly coupled to” another element or layer, there are no intervening elements or layers present. It will be understood that for the purposes of this disclosure, “at least one of X, Y, and Z” can be construed as X only, Y only, Z only, or any combination of two or more items X, Y, and Z (e.g., XYZ, XYY, YZ, ZZ). As used herein, the term “and/or” includes any and all combinations of one or more of the associated listed items.

Although the terms “first”, “second”, etc. may be used herein to describe various elements, components, regions, layers, and/or sections, these elements, components, regions, layers, and/or sections should not be limited by those terms. Those terms are merely used to distinguish one element, component, region, layer, and/or section from another element, component, region, layer, and/or section. Thus, a first element, component, region, layer, and/or section described below in one embodiment could be termed a second element, component, region, layer, and/or section in another embodiment without departing from the teachings of the present disclosure.

Spatially relative terms, such as “beneath,” “below,” “lower,” “above,” “upper,” and the like, may be used herein for descriptive purposes, and to describe one element or feature's spatial relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to limit the inventive concept. As used herein, the singular forms, “a,” “an,” and “the” are intended to include the plural forms as well, unless the context clearly indicates otherwise. Moreover, the terms “comprises,” comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to plan and/or sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Exemplary embodiments of the inventive concept will be herein described with reference to the attached drawings.

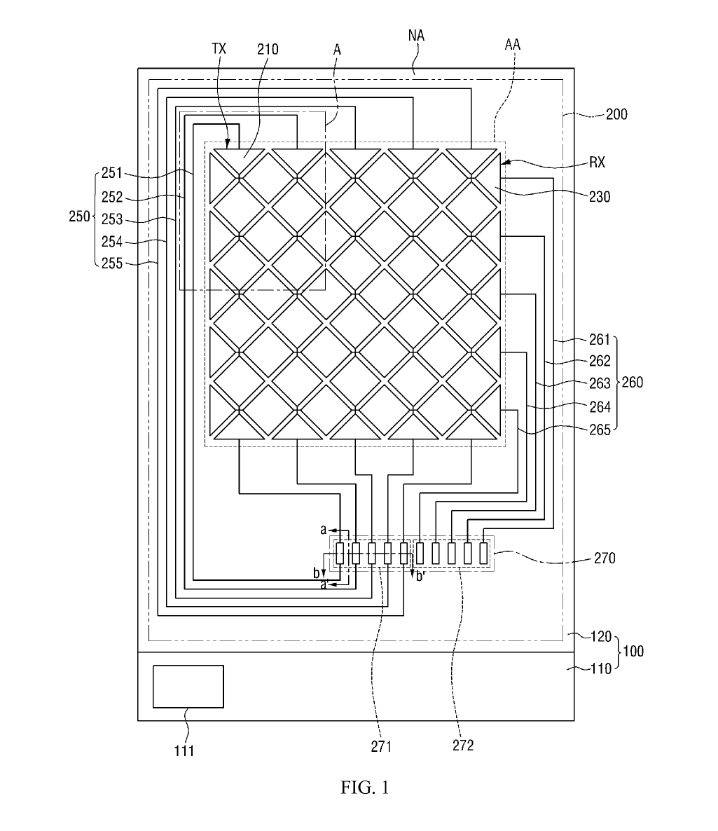

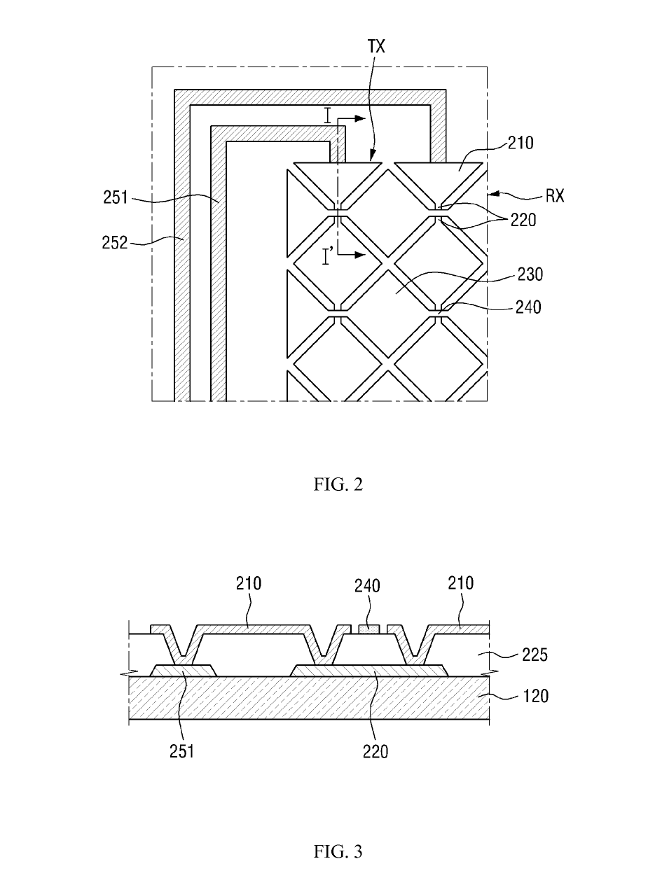

FIG. 1 is a schematic plan view of a display device according to an exemplary embodiment. FIG. 2 is a magnified view of region A of FIG. 1.

Referring to FIGS. 1 and 2, a display device according to an exemplary embodiment may include a display panel 100 and a touch panel 200.

The display panel 100 may include a first substrate 110, a second substrate 120, and a pixel unit (not shown) disposed between the first substrate 110 and the second substrate 120.

The first substrate 110 may be formed of a material such as transparent tempered glass, an acrylic resin, PET (Polyethylene Terephthalate), PC (Polycarbonate), PI (polyimide), PES (Polyethersulfone), PI (Polyimide), PMMA (PolyMethly MethaAcrylate), PEN (Polyethylene Naphthalate), Metal Foil, FRP (Fiber Reinforced Plastic), silicon rubber or the like. The first substrate 110 may be formed of a rigid material. In some other embodiments, the first substrate 110 may be formed of a ductile material, for example, a flexible material. The pixel unit (not shown) and a driving integrated circuit (IC) 111 may be disposed on an upper portion of the first substrate 110.

The pixel unit may include a plurality of scan lines and a plurality of data lines, and a plurality of pixel regions disposed in regions defined by the scan lines and the data lines. The pixel regions may include switching elements configured to be switched on/off according to a control signal applied from an external printed circuit board (not shown). The switching elements may include, for example, thin film transistors. Each pixel region may further include a light emitting device configured to emit light by controlling the switching element. A region in which the pixel unit is disposed may be referred to as a display region.

The driving IC 111 may be configured to receive an external image signal input thereto and generate a pixel control signal for controlling driving of the pixel unit, specifically by applying the pixel control signal to the scan lines and the data lines. The driving IC 111 may be mounted on the upper portion of the first substrate 110 using packaging methods such as chip-on-glass (COG), chip-on-film (COF) or the like. A region in which the driving IC 111 is disposed may be referred to as a non-display region.

The second substrate 120 may be positioned on the first substrate 110 with the pixel unit interposed therebetween.

The second substrate 120 may be formed of a material similar to that of the first substrate 110, for example, transparent tempered glass, an acrylic resin, PET (Polyethylene Terephthalate), PC (Polycarbonate), PI (polyimide), PES (Polyethersulfone), PI (Polyimide), PMMA (PolyMethly MethaAcrylate), PEN (Polyethylene Naphthalate), Metal Foil, FRP (Fiber Reinforced Plastic), silicon rubber or the like. The second substrate 120 may also be formed of a rigid material. In some other embodiments, the second substrate 120 may be formed of a ductile material, for example, a flexible material. The second substrate 120 may be smaller than the first substrate 110, such that the driving IC 111 is exposed.

The touch panel 200 may be disposed on an upper portion of the second substrate 120. The touch panel 200 may include a sensing region AA for sensing a touch input and a peripheral region NA defined as a circumferential region surrounding the sensing region AA.

As shown in FIG. 1, a portion of the sensing region AA is included in the region A. FIG. 2 is a magnified view of the region A of FIG. 1. Referring to FIG. 2, first sensing patterns 210, a first connection pattern 220, second sensing patterns 230, and a second connection pattern 240 may be disposed in a region for sensing a contact position of a hand or an object.

The peripheral region NA may be disposed in the circumferential region of the sensing region AA and may transfer sensing signals sensed by the first and second sensing patterns 210 and 230 to the outside. A first sensing wiring unit 250, a second sensing wiring unit 260, and a sensing pad unit 270 may be disposed in the peripheral region NA. The touch panel 200 will be described in greater detail with reference to FIGS. 3 through 5.

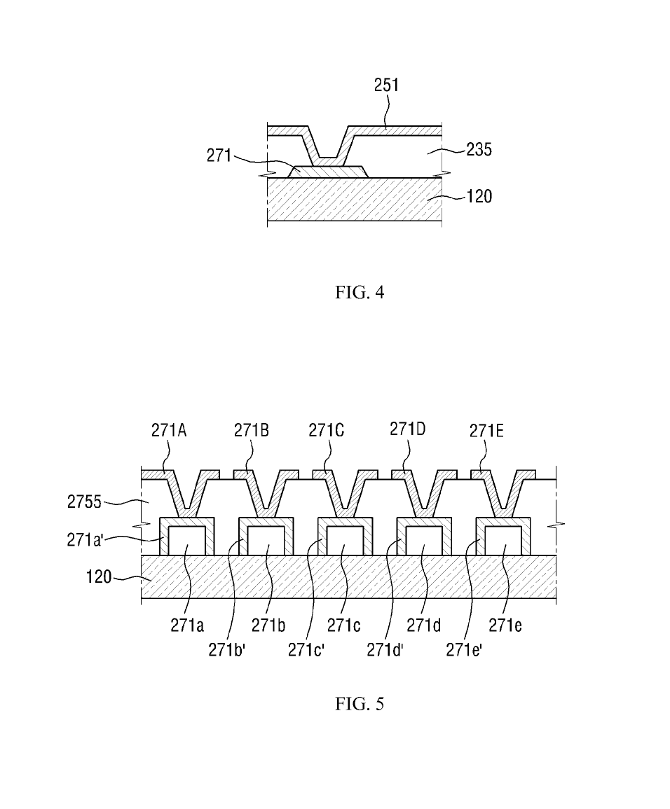

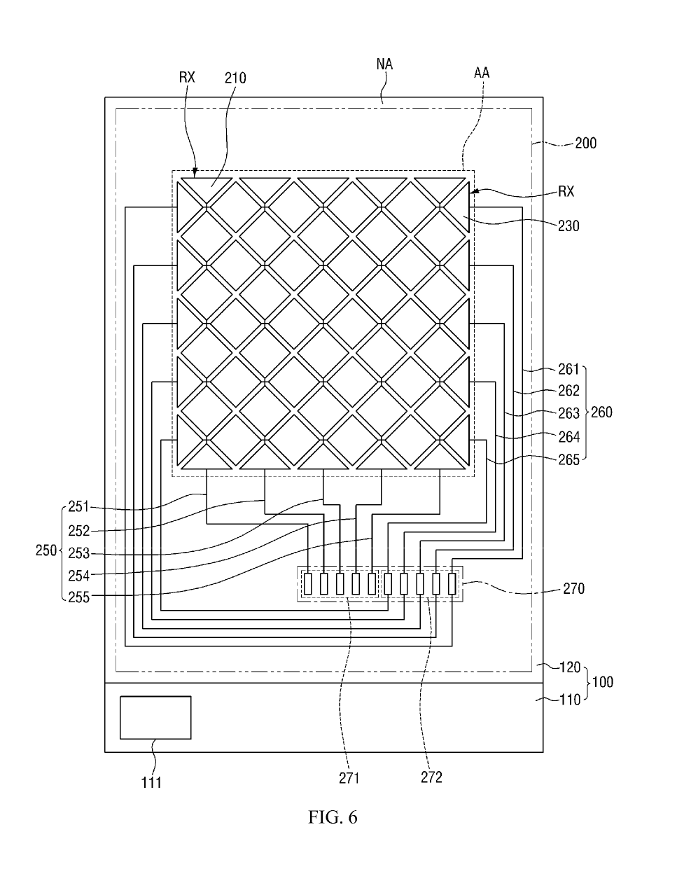

FIG. 3 is a cross-sectional view taken along line I-I′ of FIG. 2. FIG. 4 is a cross-sectional view taken along line a-a′ of FIG. 1. FIG. 5 is a cross-sectional view taken along line b-b′ of FIG. 1.

Referring to FIGS. 1 through 5, the first sensing patterns 210 may be disposed in a first direction Tx. The first sensing patterns 210 may be formed of an optically transparent, light transmissive conductive material. Here, the term “optically transparent” includes cases in which the conductive material is transparent, as well as cases in which the conductive material is opaque. If the conductive material is opaque, the sizes of the constituents of the conductive material are small and the constituents are disposed at an appropriate density such that the opaque conductive material is transparent when observed with the naked eye. The first sensing patterns 210 may be connected to the first sensing wiring unit 250 disposed in the peripheral region NA.

The first connection pattern 220 may be formed of a conductive material. The first connection pattern 220 may electrically connect the first sensing patterns 210 arranged in the first direction Tw to each other. Referring to FIG. 3, an insulating layer 225 may be formed on the first connection pattern 220. A plurality of contact holes may be formed in the insulating layer 225 to expose the first connection pattern 220, and a first sensing pattern material is deposited on exposed portions of the insulating layer provided with the contact holes, so as to form the first sensing patterns 210. Using the above process, the first sensing patterns 210 may be electrically connected to each other by the first connection pattern 220.

The second sensing patterns 230 may be disposed in a second direction Rx. The second sensing patterns 230 may be formed of an optically transparent, light transmissive conductive material. The second sensing patterns 230 may be disposed such that they are separated from the first sensing patterns 210. For example, the first sensing patterns 210 and the second sensing patterns 230 may be physically separated from each other and may not directly contact each other. In addition, the second sensing patterns 230 may be electrically isolated from the first sensing patterns 210. The first sensing patterns 210 and the second sensing patterns 230 may be positioned on the same level. That is, similar to the first sensing patterns 210, the second sensing patterns 230 too may be formed on the insulating layer 225. However, the inventive concept is not limited thereto. In some other embodiments, the second sensing patterns 230 may be formed on the second substrate 120 and contacting the second substrate 120. The second sensing patterns 230 may be connected to the second sensing wiring unit 260 disposed in the peripheral region NA.

The second connection pattern 240 may be formed of a conductive material and may electrically connect the second sensing patterns 230 disposed in the second direction Rx to each other. As illustrated in FIG. 3, to electrically insulate the second connection pattern 240 from the first connection pattern 220, the insulating layer 225 may be interposed between the first connection pattern 220 and the second connection pattern 240. Although FIG. 3 illustrates an embodiment in which the insulating layer 225 is formed on the first connection pattern 220 and sensing wirings 251, the inventive concept is not limited thereto. In some other embodiments, the insulating layer 225 may be formed on a specific portion for providing electrical insulation. For example, in those other embodiments, the insulating layer 225 may be formed only between the first connection pattern 220 and the second connection pattern 240.

The first sensing wiring unit 250 may include the plurality of first sensing wirings 251, 252, 253, 254, and 255. Referring to FIG. 1, each of the first sensing wirings 251, 252, 253, 254, and 255 may electrically connect a first sensing pattern located on one side of the first sensing patterns 210 arranged in the first direction Tx, and another first sensing pattern located on the other side of the first sensing patterns 210, to each other. For example, the first sensing wiring 251 may electrically connect a first sensing pattern located at an outermost portion of one side of the first sensing patterns 210 to another first sensing pattern located at an outermost portion of the other side of the first sensing patterns 210. A configuration in which two sensing patterns and a single sensing wiring are connected together may be referred to as a double routing scheme. Each of the first sensing wirings 251, 252, 253, 254, and 255 connecting two first sensing patterns may be formed as a single wiring on the second substrate 120 through the sensing pad unit 270. The first sensing wirings 251, 252, 253, 254, and 255 may be formed when fabricating the second substrate 120.

Referring to FIG. 4, a first sensing pad unit 271 is disposed on the second substrate 120 and contacting the second substrate 120. An insulating layer 235 is disposed on the second substrate 120 and the first sensing pad unit 271. Contact holes are formed in the insulating layer 235 exposing a portion of the first sensing pad unit 271. The first sensing wiring 251 is disposed on the insulating layer 235 having the contact holes. The first sensing wiring 251 connects a first-first sensing wiring that is connected to a first sensing pattern located at an outermost portion of one side of the first sensing patterns 210 arranged in the first direction Tx with a first-second sensing wiring that is connected to a first sensing pattern located at an outermost portion of the other side of the first sensing patterns 210 arranged in the first direction Tx. The first sensing wiring unit 250 may be formed of the same material as the first and second sensing patterns 210 and 230. In forming the second substrate 120, the wires of the first sensing wiring unit 250 connect a first sensing pattern (located on one side of the first sensing patterns 210 arranged in the first direction Tx) and another first sensing pattern (located on the other side of the first sensing patterns 210) to each other through the sensing pad unit 270, such that the number of sensing pads forming the sensing pad unit 270 may be reduced and a size of a flexible touch circuit board disposed on the sensing pad unit 270 may also be reduced.

The second sensing wiring unit 260 may include a plurality of second sensing wirings 261, 262, 263, 264, and 265. The second sensing wirings may be connected to the second sensing patterns 230 arranged in the second direction Rx. Unlike the first sensing wiring unit 250, the second sensing wirings 261, 262, 263, 264, and 265 in the second sensing wiring unit 260 may be connected to the respective individual second sensing patterns 230. A configuration in which the sensing patterns are connected to the respective sensing wirings may be referred to as a single routing scheme. The second sensing wirings 261, 262, 263, 264, and 265 may be connected to the respective pads forming the sensing pad unit 270. The sensing wiring unit 260 may be formed of the same material as the second sensing pattern 230.

The sensing pad unit 270 may be electrically connected to the first sensing wiring unit 250 and the second sensing wiring unit 260. The sensing pad unit 270 may be configured to transmit sensing signals transferred through the first sensing wiring unit 250 and the second sensing wiring unit 260 to the outside. A flexible touch circuit board (not shown) may be disposed on the sensing pad unit 270 to allow the sensing pad unit 270 to be electrically connected to the outside. The sensing pad unit 270 may include a first sensing pad unit 271 electrically connected to the first sensing wiring unit 250 and a second sensing pad unit 272 electrically connected to the second sensing wiring unit 260.

A number of first sensing pads are provided in the first sensing pad unit 271. The number of first sensing pads may correspond to half the number of the first sensing patterns 210. In some embodiments, the number of first sensing pads may be the same as the number of the first sensing wirings 251, 252, 253, 254 and 255. For example, in an embodiment in which there are ten first sensing patterns 210, and five of each of the first sensing wirings 251, 252, 253, 254 and 255 connecting to the first sensing patterns 210, there would be five first sensing pads provided in the first sensing pad unit 271. One end of the first sensing pad unit 271 may be connected to the first-first sensing wiring connected to a first sensing pattern located at an outermost portion of one side of the first sensing patterns 210 arranged in the first direction Tx, and the other end of the first sensing pad unit 271 may be connected to the first-second sensing wiring connected to another first sensing pattern located at an outermost portion of the other side of the first sensing patterns 210 arranged in the first direction Tx.

Referring to FIG. 5, the first sensing pad unit 271 may be formed on the second substrate 120. In the respective first sensing pads of the first sensing pad unit 271, first pad layers 271a, 271b, 271c, 271d, and 271e formed of a transparent conductive material may be formed on the second substrate 120, and second pad layers 271a′, 271b′, 271c′, 271d′, and 271e′ may be formed on the first pad layers 271a, 271b, 271c, 271d, and 271e encapsulating the first pad layers 271a, 271b, 271c, 271d, and 271e. In some embodiments, the second pad layers 271a′, 271b′, 271c′, 271d′, and 271e′ may be formed of a metal material. An insulating layer 2755 may be formed on the resulting structure and a plurality of contact holes may be formed in the insulating layer 2755 so as to expose upper portions of the second pad layers 271a′, 271b′, 271c′, 271d′, and 271e′. Next, third pad layers 271A, 271B, 271C, 271D, and 271E formed of a transparent conductive material may be formed on a surface of the resulting structure having the contact holes, thereby forming the first sensing pad unit 271 according to an exemplary embodiment.

A number of second sensing pads may be disposed in the second sensing pad unit 272. The number of second sensing pads may be the same as the number of second sensing patterns 230 and the number of second sensing wirings 261, 262, 263, 264 and 265. For example, in an embodiment in which there are five second sensing patterns 230 and five of each of the second sensing wirings 261, 262, 263, 264 and 265 connecting the second sensing patterns 230 to each other, there will be five pads forming the second sensing pad unit 272. The second sensing pad unit 272 may be formed having the same shape as the first sensing pad unit 271.

FIG. 6 is a schematic plan view of a display device according to another exemplary embodiment.

The touch panel 100 of FIG. 6 is similar to the touch panel 100 of FIG. 1. However, a portion of the touch panel 200 of FIG. 6 is different from the touch panel 200 of FIG. 1. In the touch panel 200 of FIG. 6, a scheme for connecting the first sensing wiring unit 250 and the first sensing patterns 210 arranged in the first direction Tw to each other and a scheme for connecting the second sensing wiring unit 260 and the second sensing patterns 230 arranged in the second direction Rw to each other may be different from that of FIG. 1. As previously mentioned, FIG. 1 illustrates an embodiment in which the first sensing wiring unit 250 may be arranged in a double routing scheme and the second sensing wiring unit 260 may be arranged in a single routing scheme. In contrast, FIG. 6 illustrates an embodiment in which the first sensing wiring unit 250 may be arranged in a single routing scheme and the second sensing wiring unit 260 may be arranged in a double routing scheme. In the embodiment of FIG. 6, the second sensing wirings of the second sensing wiring unit 260 may be connected to the respective single pads and further connected to each other as a single wiring on the second substrate 120 though the respective single pads. Since the other elements and their configurations in FIG. 6 are similar to those of FIG. 1, a detailed description of those similar elements and their configurations will be omitted.

In some embodiments (not illustrated), both of the first sensing wiring unit 250 and the second sensing wiring unit 260 may be implemented in a double routing scheme. When both of the first sensing wiring unit 250 and the second sensing wiring unit 260 are implemented in a double routing scheme, the number of sensing pads forming the sensing pad unit 270 may be further reduced.

While exemplary embodiments have been shown and described above, it will be apparent to those skilled in the art that modifications and variations could be made without departing from the scope of the inventive concept as defined by the appended claims.

What is claimed is:

1. A display device comprising:
a first substrate;
a plurality of first sensing patterns positioned on a first surface of the first substrate and arranged in a first direction;
a plurality of second sensing patterns positioned on the first surface of the first substrate and arranged in a second direction intersecting with the first direction;
a first sensing wiring unit including a plurality of first sensing wirings connected to the first sensing patterns;
a second sensing wiring unit including a plurality of second sensing wirings connected to the second sensing patterns; and
a sensing pad unit including a first sensing pad unit and a second sensing pad unit, wherein the first sensing pad unit includes a plurality of first sensing pads connected to the first sensing wiring unit and the second sensing pad unit includes a plurality of second sensing pads connected to the second sensing wiring unit,
wherein one end of the first sensing wiring unit is connected to the first sensing patterns that are located on one side of the first sensing patterns arranged in the first direction, and the other end of the first sensing wiring unit is connected to the first sensing patterns that are located on the other side of the first sensing patterns arranged in the first direction, and
wherein the first sensing wiring unit electrically connects the first sensing patterns that are located on the one side and the first sensing patterns that are located on the other side to each other through the first sensing pad unit.

2. The display device of claim 1, wherein the first sensing patterns are electrically connected to each other, and
wherein a first connection pattern electrically connects the first sensing patterns to each other.

3. The display device of claim 2, wherein the second sensing patterns are electrically connected to each other, and
wherein a second connection pattern electrically connects the second sensing patterns to each other.

4. The display device of claim 3, wherein the first connection pattern and the second connection pattern are arranged in different layers.

5. The display device of claim 4, wherein an insulating material is interposed between the first connection pattern and the second connection pattern.

6. The display device of claim 1, wherein the second sensing wiring unit is connected to each of the second sensing patterns.

7. The display device of claim 1, wherein one end of the second sensing wiring unit is connected to the second sensing patterns that are located on one side of the second sensing patterns arranged in the second direction, and the other end of the second sensing wiring unit is connected to the second sensing patterns that are located on the other side of the second sensing patterns arranged in the second direction.

8. The display device of claim 7, wherein the second sensing wiring unit electrically connects the second sensing patterns that are located on the one side and the second sensing patterns that are located on the other side to each other through the second sensing pad unit.

9. The display device of claim 1, wherein the number of the first sensing pads is half the number of the first sensing patterns.

10. The display device of claim 1, wherein the number of the second sensing pads is the same as the number of the second sensing patterns.

11. The display device of claim 1, wherein a second substrate is disposed on a second surface of the first substrate, and
wherein a plurality of pixel regions are arranged on the second substrate.

12. A display device comprising:
a substrate;
a plurality of first sensing patterns arranged on the substrate in a first direction;
a plurality of second sensing patterns arranged on the substrate in a second direction intersecting with the first direction;
a plurality of first sensing pads for transmitting sensing signals sensed by the plurality of first sensing patterns;
a plurality of second sensing pads for transmitting sensing signals sensed by the plurality of second sensing patterns;
a plurality of first sensing wirings electrically connecting the first sensing patterns and the first sensing pads to each other; and
a plurality of second sensing wirings electrically connecting the second sensing patterns and the second sensing pads to each other,
wherein one side of the first sensing pads are connected to one end of the first sensing wirings that are connected to the first sensing patterns located on one side of the first sensing patterns, and
wherein the other side of the first sensing pads are connected to the other end of the first sensing wirings that are connected to the first sensing patterns located on the other side of the first sensing patterns.

13. The display device of claim 2, wherein the first sensing pads are disposed on the substrate,
an insulating layer is interposed between the first sensing pads and the first sensing wirings, and
the first sensing pads and the first sensing wirings are electrically connected to each other through contact holes formed in the insulating layer.

14. The display device of claim 12, wherein the number of the first sensing pads is half the number of the first sensing patterns.

15. The display device of claim 12, wherein the second sensing pads are connected to the second sensing wirings, and
the second sensing wirings are connected to the second sensing patterns.

16. The display device of claim 15, wherein the number of the second sensing pads is the same as the number of the second sensing patterns.

17. The display device of claim 12, wherein one side of the second sensing pads are connected to one end of the second sensing wirings that are connected to the second sensing patterns located on one side of the second sensing patterns, and
the other side of the second sensing pads are connected to the other end of the second sensing wirings that are connected to the second sensing patterns located on the other side of the second sensing patterns.

18. The display device of claim 17, wherein the number of the second sensing pads is half the number of the second sensing patterns.

19. The display device of claim 12, wherein the first sensing patterns are electrically connected to each other, and
wherein a first connection pattern electrically connects the first sensing patterns to each other.

20. The display device of claim 12, wherein the second sensing patterns are electrically connected to each other, and
wherein a second connection pattern electrically connects the second sensing patterns to each other.
